(19) United States
(12) Patent Application Publication
(10) Pub. No.: US 2018/0283295 A1
(43) Pub. Date: Oct. 4, 2018

(54) ENGINE OUT NOX CONTROLLER

(71) Applicant: GM Global Technology Operations LLC, Detroit, MI (US)

(72) Inventors: Giovanni Montinaro, San Pietro Vernotico (IT); Giancarlo Cifali, Turin (IT)

(21) Appl. No.: 15/475,887

(22) Filed: Mar. 31, 2017

(51) Int. Cl. F02D 41/00; F01N 11/00; F02M 26/14; F02D 41/02

(52) U.S. Cl. CPC F02D 41/0002; F01N 11/007; F02D 2041/0017; F02D 41/0235; F02D 41/0065; F02M 26/14

(57) ABSTRACT

A vehicle includes an internal combustion engine, and an exhaust gas recirculation system that recirculates a portion of exhaust gas into at least one cylinder. A throttle body assembly includes a throttle valve movable according to a plurality of angles between an open position and a closed position. The angle of the throttle valve adjusts a pressure differential across the exhaust gas circulation system to modify an amount of recirculated exhaust gas recirculated back to the engine. The vehicle further includes an engine controller configured to determine a target NOx flow rate corresponding to a given driving condition of the vehicle. The engine controller actively adjusts the position of a throttle valve and/or an EGR valve based on a comparison between the measured NOx flow rate and the target NOx flow rate to reduce emissions of NOx exhausted by the vehicle.

### INTRODUCTION

The present disclosure relates to automotive vehicles, and more particularly, to engine control systems of an automotive vehicle.

Vehicle engine systems such as compression-type engine systems (e.g., diesel engines) can employ an exhaust gas recirculation (EGR) system to reduce emissions of oxides of nitrogen (NOx) from the vehicle by recirculating a portion of engine exhaust gas back to the engine fresh air intake. The recirculated exhaust gas decreases the level of oxygen during the engine combustion process, and reduces the capacity of the engine intake air charge to absorb heat. Accordingly, combustion temperature is lowered, which frustrates NOx production thereby reducing overall NOx output from the vehicle.

Although the EGR system includes an EGR valve to control the amount of recirculated gas delivered to the engine fresh air intake, the throttle valve of the vehicle can also influence the amount of recirculated gas flowing through the EGR system. For instance, the intake throttle can effect a pressure differential in the intake manifold which creates a pressure differential across the EGR valve. This pressure differential induces the flow of exhaust gas to pass from the exhaust manifold to the intake manifold via an EGR recirculation conduit. The EGR system typically operates according to various EGR system set point values that control the position of the throttle valve. However, various environmental conditions and/or driving conditions can render the EGR system set points inaccurate, thereby influencing the overall NOx output of the vehicle.

### SUMMARY

According to a non-limiting embodiment, an engine system included in a vehicle comprises an internal combustion engine, a NOx sensor, an exhaust recirculation system, a throttle body assembly, and an electronic hardware engine controller. The internal combustion engine includes an intake system that conveys air to at least one cylinder. The at least one cylinder is configured to combust a mixture of fuel and the air thereby generating exhaust gas containing nitrogen oxides (NOx). The NOx sensor is configured to measure the NOx flow rate associated with the NOx. The exhaust gas recirculation system is configured to recirculate a portion of exhaust gas into the at least one cylinder. The throttle body assembly includes a throttle valve movable according to a plurality of angles between an open position and a closed position. The angle of the throttle valve adjusts a pressure differential across the exhaust gas circulation system that modifies an amount of recirculated exhaust gas conveyed through the exhaust gas recirculation system. The electronic hardware engine controller is in signal communication with the NOx sensor and the throttle body assembly. The engine controller is configured to determine a target NOx flow rate corresponding to a given driving condition, and to actively adjust the position of the throttle valve based on a comparison between the measured NOx flow rate and the target NOx flow rate.

The engine system includes one or more additional features such as, wherein the engine controller actively adjusts at least one of a position of an EGR valve included in the EGR system and a position of the throttle valve to maintain the target NOx flow rate at a given driven condition of the vehicle.

According to another feature, the engine controller determines an initial EGR set point value based on a mass flowrate of the air entering the intake system, and modifies the EGR set point value based on at least the measured NOx flow rate, wherein electronic hardware engine controller controls the exhaust gas recirculation system to regulate the amount of recirculated exhaust gas delivered to the engine based on the modified EGR set point value.

According to another feature, regulating the amount of recirculated exhaust gas includes adjusting the EGR valve and the throttle valve.

According to another feature, the engine controller performs the comparison to determine a NOx difference signal indicating a difference (ΔNOx) between the measured NOx flow rate and the target NOx flow rate, and modifies the initial EGR set point value based on the ΔNOx.

According to another feature, the target NOx flow rate is based on a comparison between at least one measured vehicle operating condition and a NOx LUT that cross-references a plurality of target NOx flow rate values with at least one reference vehicle operating condition.

According to another feature, the measured vehicle operating condition is at least one of engine speed and engine load, and wherein the at least one reference vehicle operating condition is a reference engine speed and a reference engine load.

According to another feature, the engine controller determines an air mass set point value based on the mass flowrate of air, and modifies the air mass set point value based on the measured NOx flow rate.

According to still another feature, the engine controller adjusts the throttle valve of the throttle assembly based on the modified air mass set point value.

According to yet another feature, the engine controller determines an air temperature compensation value based on a temperature of the air, and applies the air temperature compensation value and the ΔNOx to the initial EGR set point value to generate the modified EGR set point value.

According to another feature, the engine controller modifies the temperature compensation value based on a barometric/atmospheric pressure correction value.

According to yet another feature, the engine controller stores at least one pressure LUT that cross-references a plurality of barometric/atmospheric pressure correction value with respect to a reference barometric/atmospheric pressure value, determines the barometric/atmospheric pressure correction value based on a comparison between a measured barometric/atmospheric pressure correction value and the pressure LUT.

According to another non-limiting embodiment, a method of reducing a level of nitrogen oxides (NOx) exhausted from a vehicle comprises conveying air to at least one cylinder to combust a mixture of fuel and the air thereby generating exhaust gas containing NOx, and measuring a NOx flow rate associated with the NOx. The method further includes recirculating a portion of exhaust gas into the at least one cylinder, and adjusting a pressure differential across the exhaust gas circulation system to modify an amount of recirculated exhaust gas conveyed through the exhaust gas recirculation system. The method further includes determining a target NOx flow rate corresponding to a given driving condition, and actively adjusting a position of a throttle valve to adjust the pressure differential based on a comparison between the measured NOx flow rate and the target NOx flow rate.

The method includes one or more additional features such as actively adjusting at least one of a position of an EGR valve included in the EGR system and a position of the throttle valve to maintain the target NOx flow rate at a given driven condition of the vehicle.

The method further includes actively adjusting at least one of a position of an EGR valve included in the EGR system and a position of the throttle valve to maintain the target NOx flow rate at a given driven condition of the vehicle.

The method further includes determining an initial EGR set point value based on a mass flowrate of the air entering the intake system, modifying the EGR set point value based on at least the measured NOx flow rate, and controlling the exhaust gas recirculation system to regulate the amount of recirculated exhaust gas delivered to the engine based on the modified EGR set point value.

The method further includes a feature, wherein controlling the exhaust gas recirculation system includes adjusting the EGR valve and the throttle valve.

The method further includes a feature, wherein the comparison includes determining a difference (ΔNOx) between the measured NOx flow rate and the target NOx flow rate, and wherein the initial EGR set point value is modified based on the ΔNOx.

The method further includes a feature, wherein the target NOx flow rate is based on a comparison between at least one measured vehicle operating condition and a NOx LUT that cross-references a plurality of target NOx flow rate values with at least one reference vehicle operating condition.

The method further includes determining an air mass set point value based on the mass flowrate of air, and modifies the air mass set point value based on the measured NOx flow rate.

The method further includes adjusting the throttle valve based on the modified air mass set point value.

The above features of the disclosure are readily apparent from the following detailed description when taken in connection with the accompanying drawings.

### BRIEF DESCRIPTION OF THE DRAWINGS

Other features and details appear, by way of example only, in the following detailed description, the detailed description referring to the drawings in which:

FIG. 1 is a diagram illustrating an engine system of an automotive vehicle according to a non-limiting embodiment;

FIG. 2 is a block diagram of an electronic hardware engine controller including an air system control module and a NOx control module configured to modify EGR system set points based on nitrous oxide (NOx) flowrate according to a non-limiting embodiment;

FIG. 3 is a block diagram of an electronic hardware engine controller in signal communication with an electronic hardware barometric correction controller according to a non-limiting embodiment; and

FIG. 4 is a flow diagram illustrating a method of controlling an engine system based on NOx flowrate according to a non-limiting embodiment.

### DETAILED DESCRIPTION

The following description is merely exemplary in nature and is not intended to limit the present disclosure, its application or uses. It should be understood that throughout the drawings, corresponding reference numerals indicate like or corresponding parts and features. As used herein, the term module or unit refers to processing circuitry that may include an application specific integrated circuit (ASIC), an electronic circuit, an electronic hardware processor (shared, dedicated, or group) and memory that executes one or more software or firmware programs, a microprocessor, a combinational logic circuit, and/or other suitable components that provide the described functionality.

Traditional engine control systems can experience a lag from the time at which current vehicle operating conditions are measured to the time at which one or more engine components are controlled based on the measured conditions. In addition, variations in components (e.g., injection timing, combustion chamber dimensions, piston dimensions, etc.) from vehicle to vehicle can impact calibrated set points.

Various not limiting embodiments of the invention provide an engine system that utilizes EGR system set points, stored in a memory of an engine controller which controls various engine components, to reduce NOx output. Unlike conventional engine systems, however, the engine system provides a closed-loop control system that utilizes NOx measurements to dynamically modify the stored EGR system set points.

The fuel consumption efficiency of an automotive internal combustion engine can be measured in terms of brake specific fuel consumption (BSFC). The BSFC is the rate of fuel consumed by the internal combustion engine divided by the power produced by the engine. Local atmospheric conditions can affect engine fuel consumption and therefore impact BSFC. For instance, as the atmospheric pressure of the vehicle changes (i.e., the vehicle travels from a low altitude location to a high altitude location), the original EGR system set points may no longer identify the fuel consumption necessary to achieve the most efficient (BSFC).

The change in atmospheric pressure, however, has minimal or no impact on the flow rate of NOx flowing through the exhaust system. Therefore, at least one non-limiting embodiment described herein provides a NOx sensor that measures the NOx flow rate (i.e., flow rate of NOx measured in grams per second) and the engine controller calculates a correction value based on the measured NOx flow rate. The correction value is then applied to the EGR system set points. The resulting modified EGR system set points (as opposed to the original EGR system set points) are then used to control the EGR system and/or the air intake throttle valve to maintain a target BSFC regardless of variations in atmospheric pressure and/or variations in vehicle component designs.

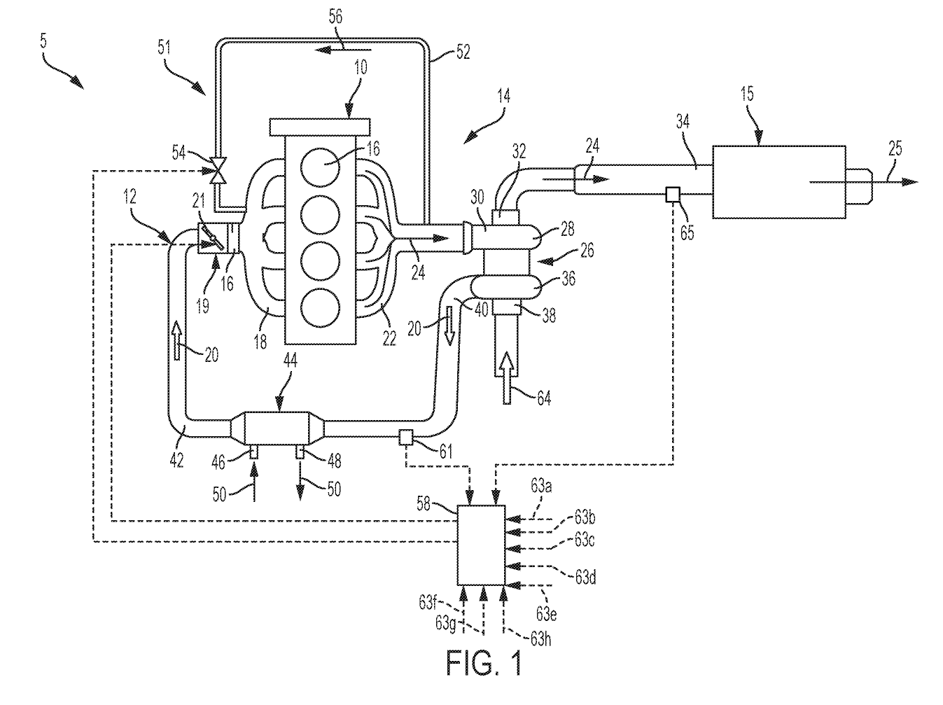

Referring now to FIG. 1, a vehicle system 5 is illustrated according to a non-limiting embodiment. The vehicle system 5 includes an internal combustion engine 10 having an intake system 12 and an exhaust system 14. Various types of engine architectures be implemented including, but not limited to, spark-ignited gasoline engines, compression-type engines (e.g., diesel engines), and hybrid engine systems which incorporate an electric motor in conjunction with an internal combustion engine.

The internal combustion engine 10 includes a plurality of cylinders 16 into which a combination of air and fuel are introduced. The combination of air and fuel is sometimes referred to as an intake charge. Although four cylinders 16 are illustrated, the engine 10 may include any number of cylinders 16. The intake charge is combusted in the cylinders 16 resulting in reciprocation of pistons (not shown) therein. The reciprocation of the pistons rotates a crankshaft (not shown) to deliver motive power to a vehicle powertrain or to a generator or other stationary recipient of such power in the case of a stationary application of the internal combustion engine 10.

The intake system 12 includes an intake manifold 18, in fluid communication with the cylinders 16. The intake manifold 18 receives a compressed intake charge 20 (e.g., compressed air) from the intake system 12 through a throttle body assembly 19 having an air intake throttle valve 21, and delivers the charge to the plurality of cylinders 16. The exhaust system 14 includes an exhaust manifold 22, in fluid communication with the cylinders 16 that is configured to remove the combusted constituents of the intake charge (i.e. exhaust gas 24) and to deliver it to a turbine 28 of an exhaust driven turbocharger 26 that is located in fluid communication therewith. The turbine 28 includes a high pressure turbine housing inlet 30 and a low pressure turbine housing outlet 32. The low pressure turbine housing outlet 32 is in fluid communication with the remainder of exhaust system 14 and delivers the exhaust gas 24 to an exhaust gas conduit 34.

The exhaust driven turbocharger 26 can also include a compressor wheel (not shown) that is housed within a compressor housing 36. The compressor housing 36 includes a low pressure inlet 38 that is typically in fluid communication with ambient air 64 and a high pressure outlet 40. The high pressure outlet 40 is in fluid communication with the intake system 12 and delivers the compressed intake air 20 through an intake conduit 42 to the intake manifold 18 for delivery to the cylinders 16 of the internal combustion engine 10.

In an exemplary embodiment, disposed inline of intake conduit 42, and between the outlet 40 of the compressor housing 36 and the intake manifold 18, is a charge air cooler 44. The charge air cooler 44 receives heated (due to compression) compressed intake air from the compressor 36 and cools the compressed intake air. The compressed cool air is delivered to the intake manifold 18 through a subsequent portion of the intake charge conduit 42. The air charge cooler 44 may comprise an inlet 46 and an outlet 48 for the circulation of a cooling medium 50 (such as a glycol-based automotive coolant or ambient air) therethrough. In a known manner, the intake air cooler 44 transfers heat from the compressed intake air 20 to the cooling medium 50 thereby reducing the temperature and increasing the density of the compressed intake air 20 as it transits the air charge cooler 44.

Located in fluid communication with the exhaust system 14, and in the exemplary embodiment shown in FIG. 1, is an exhaust gas recirculation (“EGR”) system 51, including an EGR conduit 52 that is in fluid communication with the high pressure turbine housing inlet 30. The EGR conduit 52 is located on the upstream, high pressure side of the exhaust driven turbocharger 26, and is configured to divert a portion 56 of the exhaust gas 24 from the turbine housing inlet 30 and to return it to, or recirculate it to, the intake system 12, as will be further described herein. In the embodiment shown in FIG. 1, the EGR conduit 52 fluidly connects to the intake system 12, downstream of the throttle body assembly 19. An EGR valve 54 is fluidly connected to the EGR conduit 52 and is configured to control the flow of diverted exhaust gas 56 therethrough and to the intake system 12 of the internal combustion engine 10.

The EGR system 51 is in signal communication with a control module, such as an engine controller 58, which is configured to operate the EGR valve 54 to adjust the volumetric quantity of diverted exhaust gas 56 that is introduced to the intake system 12, based on the particular engine operating conditions at any given time. The engine controller 58 collects information regarding the operation of the internal combustion engine 10 from various sensors. For example, a mass air flow (MAF) sensor 61 measures the mass of the air entering the intake system 12. Additional sensors can also be installed in the vehicle system to output signals indicating various operating conditions including, but not limited to, engine speed/load 63a, the exhaust system temperature 63b, engine coolant temperature/flow 63c, throttle valve position 63d, ambient air temperature 63e, barometric/atmospheric pressure 63f, exhaust gas flow/temperature 63g, and driver torque demand 63h (e.g., accelerator pedal position). One or more of these signals 63a-63h can be utilized to determine the appropriate flow of exhaust gas to be recirculated to the intake system 12.

During operation, the amount of recirculated exhaust gas 56 delivered to the engine intake 18 using only the EGR valve 54 may reach a maximum limit even when the EGR valve 54 is not fully open (e.g., is open at 80%). However, the throttle body assembly 19 can be used to establish a pressure differential across the EGR valve 54 which further adjusts the amount of recirculation of exhaust gas 56 delivered to the engine intake 18. In at least one embodiment, the position of the throttle valve 21 is controlled according to EGR system set points, which establish a throttle valve position as a function of engine speed, fuel quantity, engine temperature, ambient pressure and temperature. Accordingly, the throttle valve 21 can be adjusted along with the EGR valve 54 to vary the pressure differential across the EGR valve 54, thereby increasing the amount of recirculated exhaust gas 56 delivered to the engine intake 18.

The vehicle system 5 further includes an exhaust treatment system 15. The exhaust treatment system 15 can include one or more exhaust aftertreatment devices (not shown) that are configured to treat various regulated constituents of the exhaust gas 24. The exhaust after treatment devices include, but are not limited to, an oxidation catalyst (OC) such as a diesel oxidation catalyst (DOC), a selective catalytic reduction (SCR) device, and a particular filter such as a diesel particular filter (DPF). The OC is useful in treating unburned gaseous and non-volatile HC and CO, which are oxidized to form carbon dioxide and water. The SCR device may be disposed downstream of the OC, and is configured to convert NOx constituents in the exhaust gas 24 into diatomic nitrogen (N₂), and water (H₂O) in the presence of a catalyst reductant such as, for example, urea. The PF may be disposed downstream from the SCR device, and filters the exhaust gas 24 of carbon and other particulate matter (e.g. soot). After exiting the exhaust treatment system 15, the treated exhaust gas 25 is then expelled from the exhaust system 14.

The vehicle system 5 further includes a NOx sensor 65 in signal communication with the engine controller 58. The NOx sensor 65 is disposed near the inlet of the exhaust treatment system 15 and is configured to measure an amount of NOx contained in the exhaust gas 24. Unlike conventional vehicle systems that operate the EGR system and air intake based solely on the initial EGR system set points stored in memory of an engine control unit, at least one embodiment described herein provides an engine controller 58 that generates one or more modified EGR system set points based on the NOx flow rate through the exhaust system 14. In at least one embodiment, the EGR system set points include a first group of air mass set point values and a second group of EGR rate set point values. Each of these groups of set point values can be used to control the intake throttle valve 21 and/or the EGR valve 54, respectively, in order to achieve a desired NOx output as described herein.

The engine controller 58 generates a correction value based on the NOx flow rate measured by the NOx sensor 65, and applies the correction value to one or more of the initial EGR system set points to generate the modified EGR system set point. Because NOx flow rate is less sensitive to changes in various operating conditions such as, for example, atmospheric pressure, coolant temperature, etc., the NOx flow rate can be used to correct the initial EGR system set points as the vehicle experiences changes in its operating conditions. Accordingly, the EGR system 51 can be controlled more precisely to reduce NOx output along with improving the BSFC of the vehicle. Moreover, because the NOx flow rate is measured downstream from the engine 10, the EGR system set points can be corrected to compensate for vehicle component variations such as, for example, cylinder dimensions, piston dimensions, injection timing, etc., which can vary from vehicle to vehicle.

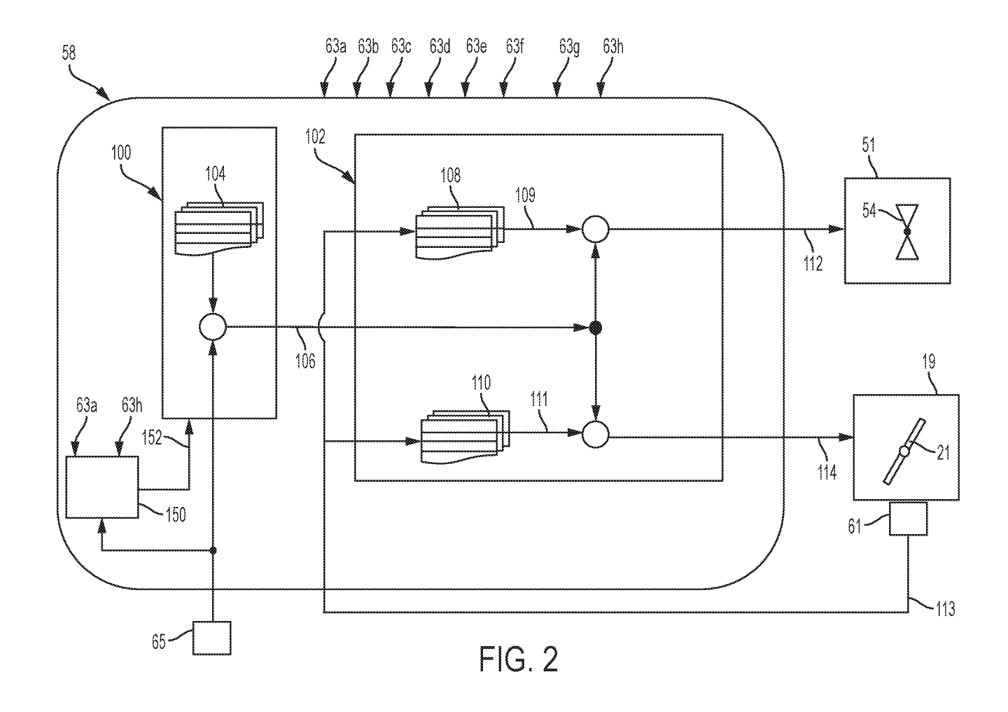

Turning now to FIG. 2, an example of engine controller 58 is configured to correct EGR system set points and improve operating efficiency of EGR system 51 based on one or more operating conditions signals 63a-63h. The engine controller 58 includes a NOx module 100 and an air system module 102. The NOx module 100 and/or the air system module 102 can be constructed as an electronic hardware controller that includes memory and a processor configured to execute algorithms and computer-readable program instructions stored in the memory.

The engine controller 58 includes an input that is in signal communication with the NOx sensor 65, and includes outputs that are in signal communication with the throttle body assembly 19 and the EGR system 51, respectively. Accordingly, a closed-loop system (i.e., feedback control system) is established that can maintain a target NOx emission output by monitoring the NOx output via the NOx sensor 65, and actively adjusting the intake valve 21 to achieve the necessary pressure differential across the EGR valve 54 for maintaining the target NOx emission output.

The NOx sensor 65 provides the NOx module 100 with measured values indicative of the NOx flow rate through the exhaust system 14 (see FIG. 1). In this manner, changes in the NOx flow rate resulting from changing vehicle operating conditions are detected and monitored by the NOx module 100. The NOx module 100 stores, in memory, one or more NOx look up tables (LUTs) 104. The NOx LUT 104 includes a plurality of target NOx flow rate values that are cross-referenced with one or more vehicle operating conditions.

The engine controller 58 is configured to determine a given operating condition of the engine system 5 (see FIG. 1), and to control one or more vehicle components in order to achieve the target NOx value corresponding with the given operating condition. For instance, EGR system 51 is configured to recirculate a portion of the exhaust gas produced by the engine 10 (see FIG. 1) back into the engine intake 18. The recirculated exhaust gas replaces some of the oxygen in the pre-combustion mixture while also lowering the temperature inside the cylinders 16. Because NOx forms primarily when a mixture of nitrogen and oxygen is subjected to high temperatures, the lower combustion chamber temperatures reduces the amount of NOx that is ultimately generated by the engine 10. Using the NOx LUT 104, the engine controller 58 can determine the target NOx rate that should be produced at a given operating condition, (e.g., a given vehicle speed and/or load), and then control the throttle valve 21 and/or the EGR valve 54 to achieve the target NOx rate.

The NOx module 100 is configured to determine a NOx error value between the NOx flow rate measured by the NOx sensor 65 at a given operating condition and the target NOx flow rate (e.g., expected NOx flow rate) at the given operating condition. Vehicle operating conditions, however, may vary based on the local environmental conditions of the engine system 5 and/or the operating behavior of the engine system. For instance, changes in altitude can impact the combustion process, which in turn impacts the rate of NOx flowing through the exhaust system 14. Component wear or component variations from vehicle to vehicle can also impact the NOx flow rate. Accordingly, there may be times where the NOx flow rate measured by the NOx sensor 65 at a given engine speed or load varies from the target value corresponding to the given engine speed and/or load as indicated by the NOx LUT 104. The NOx module 100 compares the measured NOx flow rate output from the NOx sensor 65 with the target NOx flow rate indicated by the NOx LUT 104, and generates a NOx difference (ΔNOx) signal 106 indicating the error or difference between the measured NOx flow rate and the target NOx flow rate. This ΔNOx signal 106 is used by the air system module 102 to correct the EGR system set points that can be impacted by changing conditions as described herein.

The air system module 102 is in signal communication with the NOx module 100 and the MAF sensor 61. The air system module 102 also stores one or more LUTs that assist in controlling various engine system components including, but not limited to, the EGR system 51 and the throttle body assembly 19. For instance, the air system module 102 can store an EGR LUT 108 pertaining to the EGR system 51 and a MAF LUT 110 pertaining to the throttle body assembly 19. The EGR LUT 108 includes a plurality of target EGR exhaust flow rate set point values 109 that are cross-referenced with one or more vehicle operating conditions such as, for example, MAF conveyed into the air injection system via the throttle body assembly 19. Typically, the amount of exhaust gas or the rate at which exhaust gas is recirculated back into the intake system 12 (i.e., EGR set point value 109) depends on the MAF through the throttle body assembly 19. Accordingly, the EGR set point value 109 indicates an amount of exhaust gas to be recirculated to the intake system 12 at a given MAF rate. The throttle valve 21 and/or the EGR valve 54 can be commanded into a position that achieves the target flow rate.

Similarly, the MAF LUT 110 includes a plurality of target air mass set point values 111 that are cross-referenced with one or more vehicle operating conditions. The air mass value 111 indicates a charge air quality to be delivered to the intake system 12 at a given operating condition. Accordingly, the throttle valve 21 can be commanded to a position that achieves the target air mass corresponding to the given operating condition. In addition, the MAF sensor 61 outputs an MAF signal 113 indicating the measured MAF into intake system 12. The MAF signal 113 can be utilized to adjust the position of the throttle valve 21 and regulate the MAF to the intake system 12.

The air system module 102 compares the MAF measured by the MAF sensor 61 with the EGR LUT 108 and the MAF LUT 110 to control the EGR system 51 and throttle body assembly 19, respectively, at a given operating condition. Ambient air 64 used to generate the compressed charge 20, and thus MAF through the throttle body assembly 19, can be affected by surrounding environmental conditions. For instance, ambient air is less dense at high altitudes compared to ambient air at sea level. As a result, the target air mass values stored in the MAF LUT 110 may prove to be inefficient when applied to an engine system 5 operating at high altitudes, for example. To compensate for the possible variations in MAF, the air system module 102 applies the ΔNOx signal 106 to the target EGR exhaust flow rate value 109 obtained from the EGR LUT 108 and/or to the air mass target set point 111 obtained from the MAF LUT 110. In response to applying the ΔNOx signal 106, the air system module 102 outputs a corrected EGR set point value 112 and a corrected MAF set point value 114. The EGR corrected set point value(s) 112 and the MAF corrected set point values(s) 114 are then utilized to control the EGR system 51 and throttle body assembly 19 while also compensating for variations in environmental conditions (e.g., atmospheric variations) that can impact air mass flowing into the engine system 5.

In at least one embodiment, coolant compensation values and/or air temperature compensation values can be utilized to further correct the EGR corrected set point value(s) 112 and the MAF corrected set point values(s) 114. The coolant compensation value can be determined based on a comparison between the engine coolant temperature/flow 63c and a coolant LUT (not shown). Similarly, the air temperature compensation value can be determined based on a comparison between the ambient air temperature 63e and an air temperature LUT (not shown). The coolant compensation value and the air temperature compensation value can then be applied to the ΔNOx signal 106 and the EGR set point value 109 and/or the ΔNOx signal 106 and the target air mass set point values 111 to generate the EGR corrected set point value(s) 112 and the MAF corrected set point values(s) 114.

Still referring to FIG. 2, the engine controller 58 can include a gain scheduling module 150. The gain scheduling module 150 selectively initiates the NOx module 100 to output the ΔNOx signal 106 based on whether the engine system 5 is operating in a steady-state condition or a transient condition. In at least one embodiment, the steady-state condition and transient condition can be determined based on the engine speed/load 63a, the driver torque demand 63h (e.g., accelerator pedal position), and/or the measured NOx flow rate output from the NOx sensor 65. When a steady-state condition is determined, the gain scheduling module 150 generates steady-state gain values that can be applied at a first rate to correct the error (i.e., difference) between the target engine out NOx flow rate and the measured engine out NOx flow rate. That is, the EGR system 51 is quite stable when steady-state conditions are detected. Therefore, the engine controller 58 is capable of reacting quickly to changes in measured engine out NOx flow rate to compensate for any possible drifts in target engine out NOx flow rate.

When, however, a transient condition is determined, the gain scheduling module 150 generates transient gain values that can be applied at a second rate to correct the error (i.e., difference) between the target engine out NOx flow rate and the measured engine out NOx flow rate. The second rate of transient gain values is slower than the first rate of the steady-state gain values. That is, when transient condition are detected, several, if not all, EGR system setpoint values are in the process of changing because they are depending on the engine working point. Therefore, the EGR system closed loop control working to modify the amount recirculated exhaust gas because of the change in engine speed and/or load variations. When operating in these transient conditions, it is desirable to avoid injecting additional noise into the system while attempting to modify the EGR system setpoint based on current changing NOx engine out emissions. Therefore, it is desirable for the engine controller 58 to react more slowly compared to the rate at which the steady-state gain values are applied during steady state conditions.

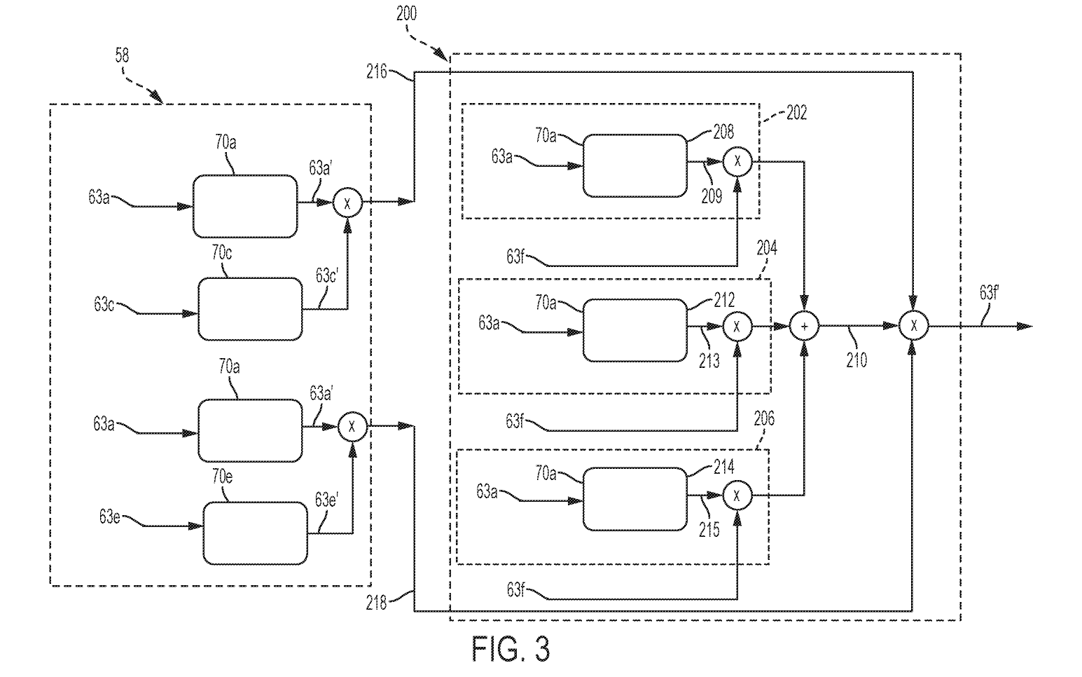

Turning to FIG. 3, a corrected barometric/atmospheric pressure value 63f can be generated, which can then be used to further improve the accuracy of the EGR corrected set point value(s) 112 and/or the MAF corrected set point values(s) 114 shown in FIG. 2. For instance, the engine system 5 can include a barometric correction controller 200 in signal communication with the engine controller 58. The output of the barometric correction controller 200 provides the corrected barometric/atmospheric pressure value 63f, which is then returned to the engine controller 58 and is utilized to dynamically correct the initially measured barometric/atmospheric pressure value 63f. Accordingly, an additional closed-loop barometric circuit is provided which further improves the precision EGR system 51 and/or MAF intake.

The barometric correction controller 200 includes, for example, a first barometric correction module 202, a second barometric correction module 204, and a third barometric correction module 206. The barometric correction controller 200, including the various barometric correction modules 202, 204 and 206, can be constructed as an electronic hardware controller that includes memory and a processor configured to execute algorithms and computer-readable program instructions stored in the memory. Although three barometric correction modules 202, 204 and 206 are illustrated, the number of barometric correction modules is not limited thereto. In this example, the first barometric correction module 202 stores a sea level LUT 208. The sea level LUT 208 includes a plurality of sea level barometric correction values that are cross-referenced with a stored engine speed value and/or a stored engine load value.

When the measured barometric/atmospheric pressure value 63f indicates that the engine system 5 is operating at sea level conditions, the first barometric correction module 202 compares the measured engine speed and/or measured engine load 63a to the sea level LUT 208 to obtain the appropriate correction value 209. The correction value 209 is then applied to the measured barometric/atmospheric pressure value 63f to generate a barometric/atmospheric pressure base value 210 at sea level conditions. Sea level conditions includes, for example, a sea level standard atmospheric pressure (p₀) of 101.325 kilopascals (kPa), and a sea level standard temperature (T₀) 288.15 Kelvin (K). In at least one embodiment, the sea level conditions include a range of sea level atmospheric pressure values which include p₀, and a range of sea level temperature values which include T₀.

The second barometric correction module 204 stores a high level LUT 212. The high level LUT 212 includes a plurality of high-level barometric correction values that are cross-referenced with a stored engine speed value and/or a stored engine load value. When the measured barometric/atmospheric pressure value 63f indicates that the engine system 5 is operating in high barometric conditions, the second barometric correction module 204 compares the measured engine speed and/or measured engine load 63a to the high level LUT 212 to obtain the appropriate correction value 213. The correction value 213 is then applied to the measured barometric/atmospheric pressure value 63f to generate a barometric/atmospheric pressure base value 210 existing at high barometric conditions. In at least one embodiment, the high level LUT 212 includes a range of high-level atmospheric pressure values that is greater than the range of sea level atmospheric pressure values, and a range of high-level temperature values that is greater than the range of sea level temperature values.

The third barometric correction module 206 stores a low level LUT 214. The low level LUT 214 includes a plurality of low-level barometric correction values that are cross-referenced with a stored engine speed value and/or a stored engine load value. When the measured barometric/atmospheric pressure value 63f indicates that the engine system 5 exists in low barometric conditions, the third barometric correction module 206 compares the measured engine speed and/or measured engine load 63a to the low level LUT 214 to obtain the appropriate correction value 215. The correction value 215 is then applied to the measured barometric/atmospheric pressure value 63f to generate a barometric/atmospheric pressure base value 210 existing at low barometric conditions. The low level LUT 214 includes a range of low-level atmospheric pressure values that is less than the range of high-level atmospheric pressure values and the range of sea level atmospheric pressure values. The low level LUT 214 also can include a range of low-level temperature values that is less than the range of high-level temperature values and the range of sea level temperature values.

Still referring to FIG. 3, the barometric/atmospheric pressure base value 210 can be further corrected based on a corrected coolant temperature value 216 and/or a corrected air temperature value 218. For example, the engine controller 58 can generate a corrected coolant temperature signal indicating the corrected coolant temperature value 216 based on the measured engine speed and/or measured engine load 63a and a measured coolant value 63c. The measured values 63a and 63c can also be compared to a stored map or curve 70a and 70c, respectively, which indicates corresponding calibrated values at a given engine condition to determine a more precise base engine speed and/or measured engine load 63a′ and base measured coolant value 63c′, before the corrected coolant temperature value 216 is generated. In a similar manner, the engine controller 58 can generate a corrected air temperature signal indicating the corrected air temperature value 218 based on the measured engine speed and/or measured engine load 63a and a measured ambient air temperature 63e. The measured values 63a and 63e can also be compared to a stored map or curve 70a and 70e, respectively, which indicates corresponding calibrated values at a given engine condition to determine a more precise base engine speed and/or measured engine load 63a′ and base measured ambient air temperature value 63e′, before the corrected air temperature value 218 is generated.

The barometric correction controller 200 applies the corrected coolant temperature value 216 and/or the corrected air temperature value 218 to the barometric/atmospheric pressure base value 210, thereby generating the final corrected barometric/atmospheric pressure value 63f. The final corrected barometric/atmospheric pressure value 63f is then returned to the engine controller 58 (see FIG. 1) and is utilized to dynamically correct the initially measured barometric/atmospheric pressure value 63f.

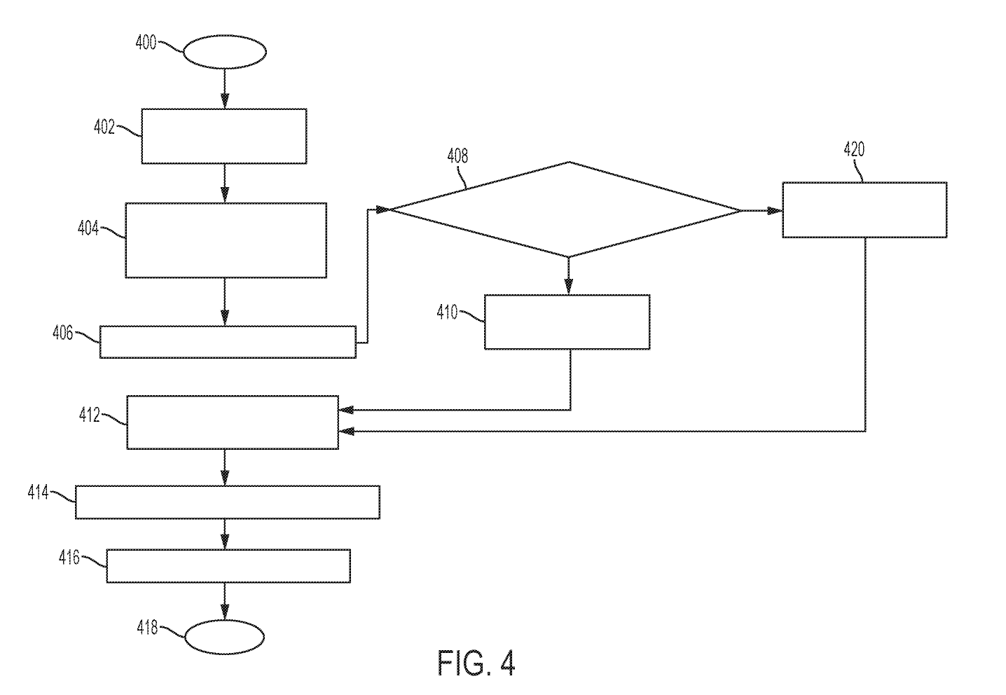

With reference now to FIG. 4, a flow diagram illustrates a method of controlling an engine system 5 according to a non-limiting embodiment. The method begins at operation 400, and at operation 402 an engine out NOx flow rate of the engine system 5 is determined. In at least one embodiment, the engine out NOx flow rate is measured, for example, using a NOx sensor 65. At operation 404, the measured NOx flow rate is compared to a target engine out NOx flow rate. In at least one embodiment, the target engine out NOx flow rate is a function of one or more given driving conditions of the engine system 5. At operation 406, a NOx emission error is generated. The NOx emission error can be calculated, for example, as the difference between the target engine out NOx flow rate and the measured engine out NOx flow rate. At operation 408, a determination is made as to whether the engine system 5 is operating in a steady-state condition. In at least one embodiment, the steady-state condition can be determined by monitoring the engine speed, overall vehicle speed, and/or requested torque (i.e., the vehicle operator torque demand indicated via the accelerator pedal). When the engine system 5 is operating at a steady-state condition, steady-state gain values are determined at operation 410. That is, when steady-state conditions are detected, the EGR system 51 is quite stable. Therefore, the engine controller 58 is capable of reacting quickly to changes in measured engine out NOx flow rate to compensate for any possible drifts in target engine out NOx flow rate. At operation 412, a corrected NOx value is determined by applying the steady-state gain values to the NOx emission error value. At operation 414, the corrected NOx value is applied to a base EGR system set point value to generate a corrected EGR system set point value. At operation 416, the EGR control system is controlled using the corrected EGR system set point value, and the method ends at operation 418.

When, however, it is determined at operation 408 that the engine system is operating in a transient condition (i.e., not in a steady-state condition), transient gain values are determined at operation 420. That is, when transient condition are detected, several, if not all, EGR system setpoint values are in the process of changing because they are depending on the engine working point. Therefore, the EGR system closed loop control working to modify the amount recirculated exhaust gas because of the change in engine speed and/or load variations. When operating in these transient conditions, it is desirable to avoid injecting additional noise into the system while attempting to modify the EGR system setpoint based on current changing NOx engine out emissions. Therefore, it is desirable for the engine controller 58 to react more slowly compared to the rate at which the steady-state gain values are applied during steady state conditions. The method then proceeds to operation 412 where a corrected NOx value is determined by applying the transient gain values to the NOx emission error value. At operation 414, the corrected NOx value is applied to a base EGR system set point value to generate a corrected EGR system set point value. At operation 416, the EGR control system is controlled using the corrected EGR system set point value, and the method ends at operation 418.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. An engine system included in a vehicle, the engine system comprising:
an internal combustion engine including an intake system that conveys air to at least one cylinder, the at least one cylinder configured to combust a mixture of fuel and the air thereby generating exhaust gas containing nitrogen oxides (NOx);
a NOx sensor configured to measure a NOx flow rate associated with the NOx;
an exhaust gas recirculation system configured to recirculate a portion of exhaust gas into the at least one cylinder;
a throttle body assembly including a throttle valve movable according to a plurality of angles between an open position and a closed position, the angle of the throttle valve adjusting a pressure differential across the exhaust gas circulation system that modifies an amount of recirculated exhaust gas conveyed through the exhaust gas recirculation system;
an electronic hardware engine controller in signal communication with the NOx sensor and the throttle body assembly, the engine controller configured to determine a target NOx flow rate corresponding to a given driving condition, and to actively adjust the position of the throttle valve based on a comparison between the measured NOx flow rate and the target NOx flow rate.

2. The engine system of claim 1, wherein the engine controller actively adjusts at least one of a position of an EGR valve included in the EGR system and a position of the throttle valve to maintain the target NOx flow rate at a given driven condition of the vehicle.

3. The engine system of claim 2, wherein the engine controller determines an initial EGR set point value based on a mass flowrate of the air entering the intake system, and modifies the EGR set point value based on at least the measured NOx flow rate, and
wherein the engine controller controls the exhaust gas recirculation system to regulate the amount of recirculated exhaust gas delivered to the engine based on the modified EGR set point value.

4. The engine system of claim 3, wherein regulating the amount of recirculated exhaust gas includes adjusting the EGR valve and the throttle valve.

5. The engine system of claim 1, wherein the engine controller performs the comparison to determine a NOx difference signal indicating a difference (ΔNOx) between the measured NOx flow rate and the target NOx flow rate, and modifies the initial EGR set point value based on the ΔNOx.

6. The engine system of claim 5, wherein the target NOx flow rate is based on a comparison between at least one measured vehicle operating condition and a NOx LUT that cross-references a plurality of target NOx flow rate values with at least one reference vehicle operating condition.

7. The engine system of claim 6, wherein the measured vehicle operating condition is at least one of engine speed and engine load, and wherein the at least one reference vehicle operating condition is a reference engine speed and a reference engine load.

8. The engine system of claim 1, wherein the engine controller determines an air mass set point value based on the mass flowrate of air, and modifies the air mass set point value based on the measured NOx flow rate.

9. The engine system of claim 8, wherein the engine controller adjusts the throttle valve of the throttle assembly based on the modified air mass set point value.

10. The engine system of claim 5, wherein the engine controller determines an air temperature compensation value based on a temperature of the air, and applies the air temperature compensation value and the ΔNOx to the initial EGR set point value to generate the modified EGR set point value.

11. The engine system of claim 10, wherein the engine controller modifies the temperature compensation value based on a barometric/atmospheric pressure correction value.

12. The engine system of claim 11, wherein the engine controller stores at least one pressure LUT that cross-references a plurality of barometric/atmospheric pressure correction value with respect to a reference barometric/atmospheric pressure value, determines the barometric/atmospheric pressure correction value based on a comparison between a measured barometric/atmospheric pressure correction value and the pressure LUT.

13. A method of reducing a level of nitrogen oxides (NOx) exhausted from an exhaust system of a vehicle, the method comprising:
conveying air to at least one cylinder, the at least one cylinder configured to combust a mixture of fuel and the air thereby generating exhaust gas containing NOx;
measuring a NOx flow rate of the NOx traveling through the exhaust system;
recirculating a portion of exhaust gas into the at least one cylinder;
adjusting a pressure differential across the exhaust gas circulation system to modify an amount of recirculated exhaust gas delivered from the exhaust gas recirculation system to the engine;
determining a target NOx flow rate corresponding to a given driving condition; and
actively adjusting a position of a throttle valve to adjust the pressure differential based on a comparison between the measured NOx flow rate and the target NOx flow rate.

14. The method of claim 13, further comprising actively adjusting at least one of a position of an EGR valve included in the EGR system and a position of the throttle valve to maintain the target NOx flow rate at a given driven condition of the vehicle.

15. The method of claim 14, further comprising:
determining an initial EGR set point value based on a mass flowrate of the air entering the intake system;
modifying the EGR set point value based on at least the measured NOx flow rate; and
controlling the exhaust gas recirculation system to regulate the amount of recirculated exhaust gas delivered to the engine based on the modified EGR set point value.

16. The method of claim 15, wherein controlling the exhaust gas recirculation system includes adjusting the EGR valve and the throttle valve.

17. The method of claim 13, wherein the comparison includes determining a difference (ΔNOx) between the measured NOx flow rate and the target NOx flow rate, and wherein the initial EGR set point value is modified based on the ΔNOx.

18. The method of claim 17, wherein the target NOx flow rate is based on a comparison between at least one measured vehicle operating condition and a NOx LUT that cross-references a plurality of target NOx flow rate values with at least one reference vehicle operating condition.

19. The method of claim 13, further comprising determining an air mass set point value based on the mass flowrate of air, and modifies the air mass set point value based on the measured NOx flow rate.

20. The method of claim 19, further comprising adjusting the throttle valve based on the modified air mass set point value.
